(19) United States
(12) Patent Application Publication
(10) Pub. No.: US 2024/0102968 A1
(43) Pub. Date: Mar. 28, 2024

(54) ULTRASONIC PROBE HOLDER WITH MECHANICAL FOLLOWER

(71) Applicant: BAKER HUGHES HOLDINGS LLC, HOUSTON, TX (US)

(72) Inventors: Qi ZHAO, Houston, TX (US); Jiaheng LI, Houston, TX (US); Xiaobin CHEN, Houston, TX (US); Jingyu YAO, Houston, TX (US)

(21) Appl. No.: 18/263,273

(22) PCT Filed: Jan. 28, 2022
(86) PCT No.: PCT/US2022/070413

§ 371 Date: Jul. 27, 2023

Related U.S. Application Data
(60) Provisional application No. 63/144,130, filed on Feb. 1, 2021.

(51) Int. Cl. G01N 29/22; G01N 29/265; G01N 29/28

(52) U.S. Cl. CPC G01N 29/225; G01N 29/265; G01N 29/28

(57) ABSTRACT

An ultrasonic probe holder includes a probe holder frame, an arc plate, a follower plate, and a plurality of contacts. The frame can have at least one aperture extending therethrough, open in the downward direction, and defining an open lower end of the frame. The arc plate can be positioned within the aperture, extend between opposed, curved lateral edges, and couple to the frame. The follower plate can be mounted to a lower end of the arc plate and include arms extending laterally outward from a vertical axis in the plane of the arc plate. The contacts can be slidably mounted to the arms of the follower plate and extend in the vertical direction. The arc plate can be constrained in the plane of the frame and to pivot with respect to the frame in response to vertical movement of one or more of the plurality of contacts.

### CROSS-REFERENCE TO RELATED APPLICATIONS

This application claims the benefit of U.S. Provisional Patent Application No. 63/144,130, filed on Feb. 1, 2020, and entitled “Ultrasonic Probe Holder With Mechanical Follower,” the entirety of which is incorporated by reference herein.

### BACKGROUND

Non-destructive testing (NDT) is a class of analytical techniques that can be used to inspect characteristics of a target, without causing damage, to ensure that the inspected characteristics of the target satisfy required specifications. NDT can be useful in industries that employ structures that are not easily removed from their surroundings (e.g., pipes or welds) or where failures would be catastrophic. For this reason, NDT can be used in a number of industries such as component manufacturing, aerospace, power generation, oil and gas transport or refining.

Ultrasonic inspection is one type of non-destructive testing technique. An ultrasonic probe can include one or more transducers that emit ultrasonic signals (sound waves) that travel within a fluid medium (e.g., oil, water, etc.) to a target under inspection. Ultrasonic echoes resulting from reflection of the transmitted ultrasonic signals at boundaries of the inspected target (e.g., outer surfaces of the target, defects within the target, etc.) can be subsequently detected by the ultrasonic transducer(s) and measured. The measured properties of the ultrasonic echoes, such as amplitude and time of flight, can be subsequently analyzed in a variety of ways to provide information regarding the target geometry (e.g., thickness), defects within the inspected part (e.g., location, size, shape, etc.), and the like.

### SUMMARY

In some cases, ultrasonic inspection can be performed when the target is submerged within a fluid couplant, referred to as immersion ultrasonic inspection. A schematic illustration of an exemplary existing immersion ultrasonic testing system 100 for inspection of cylindrical targets 114 (e.g., round bars, billets, etc.) is illustrated in FIG. 1A. A Cartesian coordinate system (e.g., x-axis, y-axis, and z-axis) is further illustrated for reference.

The system 100 includes a tank 102, an ultrasonic probe holder assembly 104, and part supporters, e.g., a pair of rollers 108 for supporting the target 114 (e.g., a round bar or billet). The tank 102 is generally rectangular, extending in a longitudinal direction (e.g., the x-direction) between opposed first and second ends 102a, 102b, and is configured to contain a liquid couplant 106. The ultrasonic probe holder assembly 104 includes at least one ultrasonic probe 110 mounted within a housing 112 that is configured to actuate vertically (e.g., up and down). Under circumstances where different regions or zones of the target 114 are to be inspected, the ultrasonic probe holder assembly 104 can include multiple ultrasonic probes 110 spaced apart from one another in the longitudinal direction (e.g., along the x-axis). As shown, the ultrasonic probe holder assembly 104 includes five ultrasonic probes 110 labeled 1-5. The housing 112 can be further mounted to the tank 102 sliding assembly (not shown) that is configured to translate the ultrasonic probe holder assembly 104 horizontally along the length of the tank 102. The pair of rollers 108 can be positioned within the tank 102 and spaced apart from one another in a width direction of the tank 102 (e.g., spaced apart in the y-direction). The pair of rollers 108 are further configured to rotate about respective longitudinal axes (e.g., axes extending in the x-direction).

In operation, the target 114 is placed on the rollers 108 and the tank 102 is filled with the liquid couplant 106 such that the target 114 is immersed therein. Rotation of the rollers 108 also causes the target 114 to rotate. As further illustrated in FIG. 1B, the housing 112 is horizontally translated to a desired location along the length of the target and vertically translated to place a bottom surface of housing 112 in contact with the target 114. So positioned, the weight of the ultrasonic probe holder assembly 104 is supported by the target 114. The housing 112 can further include actuators (not shown) that are configured to move the ultrasonic probes 110 vertically, independently of the housing 112. This movement places respective sensing surfaces from which ultrasonic signals are emitted adjacent to the target 114. Ultrasonic signals emitted from the ultrasonic probes 110, and resultant ultrasonic echoes reflected from the target 114 return to the ultrasonic probes 110 are measured and analyzed. However, existing ultrasonic inspection systems such as ultrasonic inspection system 100 have limitations that can be problematic.

In a one aspect, the ultrasonic inspection system 100 can exhibit dead zones 116 at the ends of the target 114 where ultrasonic inspection is not performed. As an example, with reference to FIG. 1B, it can be observed that during ultrasonic testing, the first and second ends 112a, 112b of the housing 112 contact with the target 114 in order to stabilize the plurality of ultrasonic probes 110. When the ultrasonic probe holder assembly 104 is near a terminal end 114t of the target 114, the distance between the terminal end 114t and the location where an ultrasonic beam 110b emitted from the ultrasonic probe closest to the terminal end 114t is referred to as the dead zone 116. It can be appreciated that dead zones 116 can be present at either terminal end 114t of the target 114 and are undesirable because these portions of the target 114 are not subjected to ultrasonic inspection.

To reduce the size (length) of the dead zones 116, it is possible to move the ultrasonic probe holder assembly 104 vertically (in the z-direction) to contact the target 114 when a leading ultrasonic probe (e.g., ultrasonic probe 1) underlies the terminal end 114t of the target 114. This scenario is illustrated in FIG. 1C. However, as a result of such a movement, only one end of the housing 112 (e.g., the second end 112b) would contact and be supported by the target 114. The first end 112a of the housing 112 remains unsupported and, given the weight of the ultrasonic probe holder assembly 104, causes undesirable rotation R of the ultrasonic probe holder assembly 104. As shown, the rotation occurs in the counterclockwise direction. It can be appreciated that a similar rotation would occur in the clockwise direction at the opposite terminal end 114t′ of the target.

In another aspect, existing ultrasonic inspection system 100 can damage the target 114 during testing. As noted above, first and second ends 112a, 112b of the housing 112 are placed in contact with the target 114 during inspection to stabilize the position of the ultrasonic probes 110 with respect to the target 114. However, given the weight of the ultrasonic probe holder assembly 104, this contact can cause the housing 112 to scratch the surface of the target 114, which is clearly undesirable in a non-destructive test.

In a further aspect, it can be desirable to position the ultrasonic probes 110 such that ultrasonic signals are normally incident upon the surface of the target 114. In this manner, transmission and reflection occur at the surface of the target 114 without a change in beam direction. At other angles of incidence, mode conversion (a change in the nature of the ultrasonic wave motion) and refection (a change in the direction of propagation of the ultrasonic wave) need to be considered when analyzing measured ultrasonic echoes. However, even under circumstances where the ultrasonic probes 110 are initially aligned to provide normal incidence of ultrasonic signals with the surface of the target 114, irregularities in the contour of the surface of the target 114 can interfere with such alignment. That is to say, existing ultrasonic testing systems 100 can lack mechanisms to compensate for irregularities in the contour of the surface of the target 114 to maintain normal incidence.

In an additional aspect, it can be desirable to control a focus or focal region of the ultrasonic signals with respect to the surface of the target 114. The focus or focal region of the ultrasonic signals represents the portion of an ultrasonic signal that exhibits maximum amplitude and is customarily positioned at the portion of the target 114 to be inspected in order to maximize the signal to noise ratio of analyzed ultrasonic echoes. The position of the ultrasonic probe 110 that places the focal region at a desired location with respect to the target 114 (e.g., at the target surface 114s, at a predetermined depth below the target surface) can change when the diameter of the target 114 changes.

It can be appreciated, however, that the ultrasonic inspection system 110 can be required to perform inspection on targets 114 having a variety of different diameters. However, existing ultrasonic inspection systems 100 can lack the ability to adjust respective ultrasonic probes 110 by coarse and fine translation and/or rotation respect to each of the coordinate axes (e.g., tilt in the y-z plain, tilt in the x-z plane, rotation about the z-axis, translation along the z-axis). Thus, it can be difficult to ensure that ultrasonic beams emitted by the ultrasonic probes 110 are oriented with respect to the target 114 for normal incidence with the target surface 114s and desired focal depth.

In an embodiment, an ultrasonic probe holder is provided. The ultrasonic probe holder can include a probe holder frame, an arc plate, a follower plate, and a plurality of contacts. The probe holder frame can have a generally planar body and at least one aperture extending therethrough. An aperture of the at least one aperture is open in the downward direction and defines an open lower end of the probe holder frame. The arc plate can be positioned within the aperture and extend between opposed, curved lateral edges. The arc plate can be coupled to the probe holder frame. The lateral edges of the arc plate can be constrained in the plane of the probe holder frame. The follower plate can be mounted to a lower end of the arc plate and can include arms extending laterally outward from a vertical axis in the plane of the arc plate. The plurality of contacts can be slidably mounted to the arms of the follower plate and extend in the vertical direction. The arc plate can be further configured to pivot with respect to the probe holder frame in response to vertical movement of one or more of the plurality of contacts.

In an embodiment, the arc plate can be is mounted to the probe holder frame by one or more springs.

In an embodiment, the ultrasonic probe holder can further include a cross-bar extending between opposed lateral edges of the aperture and at least one first pin mounted to the cross-bar and extending in a direction out of the plane of the arc plate. When the arc plate is not pivoted, the lower end of the arc plate can contact the at least one first pin.

In an embodiment, the ultrasonic probe holder can further include at least one second pin that is positioned adjacent to a lateral edge of the arc plate and configured to adjust a frictional resistance against pivoting of the arc plate.

In an embodiment, the contact can include a contact body and a contact tip positioned at a terminal end of the contact.

In an embodiment, the contact tip can include a ball and socket.

In an embodiment, an ultrasonic probe holder is provided and can include the ultrasonic probe holder, a controller, an actuator, and a probe mount. The controller can include at least one processor. The actuator can be coupled to the probe holder frame and it can be configured to move in a vertical direction in response to commands received from the controller. The probe mount can include a horizontally extending first portion. A front-facing surface of the first portion of the probe mount can be coupled to the actuator.

In an embodiment, the ultrasonic probe holder assembly can further include a limit switch mounted to the cross-bar and in electrical communication with the controller. The limit switch can be configured to transmit a limit switch signal to the controller in response to upward motion of the arc plate during downward movement of the probe holder frame by the actuator. The controller can be configured to command the actuator to stop the downward movement in response to receipt of the limit switch signal.

In an embodiment, the ultrasonic probe holder assembly can further include one or more guide rails mounted to the arc plate and extending in a horizontal direction, a gimbal slidably mounted to the one or more guide rails, and an ultrasonic probe mounted to the gimbal. The gimbal can be configured to rotate the ultrasonic probe with respect to the probe holder frame and to vertically translate the ultrasonic probe with respect to the probe holder frame.

In an embodiment, the gimbal can further include a vertically extending shaft extending between a lower end and an upper end and a plurality of horizontally extending plates disposed about the shaft and vertically offset from one another. The plurality of plates can include a base plate rigidly coupled to the shaft, an upper plate, and a middle plate vertically positioned between the base plate and the upper plate. The gimbal can also include a slidable mount coupled to the base plate and including a plurality apertures configured to receive corresponding ones of the guide rails. The ultrasonic probe can be coupled to the lower end of the shaft.

In an embodiment, the gimbal can further include a first clamp, a second clamp, and a third adjustable rod. The first clamp can be disposed about the shaft at a first vertical location and configured to exert a first clamping force on the shaft when closed. The second clamp can be disposed about the shaft at a second vertical location and configured to exert a second clamping force on the shaft when closed that is greater than the first clamping force. The third adjustable rod can be coupled to the first clamp and configured to vertically actuate to move the plurality of plates vertically with respect to the shaft.

In an embodiment, the gimbal can further include a first pivot extending in the horizontal direction and connecting the base plate and the middle plate, a fourth adjustable rod coupled to the base plate and the middle plate, and a first pair of gimbal springs positioned between the base plate and the middle plate. A first gimbal spring of the first pair can be positioned on one side of the first pivot and a second gimbal spring of the first pair can be positioned on the side of the first pivot opposite the first gimbal spring of the first pair. The fourth adjustable rod can be actuatable in the vertical direction to cause the middle plate to rotate about the first pivot.

In another embodiment, when the first clamp and the second clamp are closed, rotation of the middle plate about the first pivot can cause corresponding rotation of the ultrasonic probe about the first pivot. The first pair of gimbal springs can oppose the rotation about the first pivot such that the rotational position of the middle plate and the ultrasonic probe is approximately constant absent actuation of the fourth adjustable rod.

In an embodiment, the gimbal can further include a second pivot extending orthogonal to the horizontal direction and the vertical direction and connecting the middle plate and the upper plate, a fifth adjustable rod coupled to the middle plate and the upper plate, and a second pair of gimbal springs positioned between the middle plate and the upper plate. A first gimbal spring of the second pair can be positioned on one side of the second pivot and a second gimbal spring of the second pair can be positioned on the side of the second pivot opposite the first gimbal spring of the second pair. The fifth adjustable rod can be actuatable in the vertical direction to cause the upper plate to rotate about the second pivot.

In another embodiment, when the first clamp and the second clamp are closed, rotation of the upper plate about the second pivot can cause corresponding rotation of the ultrasonic probe about the second pivot. The second pair of gimbal springs can oppose the rotation about the second pivot such that the rotational position of the upper plate and the ultrasonic probe is approximately constant absent actuation of the fifth adjustable rod.

In another embodiment, an ultrasonic testing system is provided and it can include the ultrasonic probe holder assembly, a tank configured to contain a liquid couplant, and a sliding assembly configured to move horizontally with respect to the tank and coupled to a rear-facing surface of the first portion of the probe mount.

In an embodiment, the ultrasonic testing system can further include a plurality of ultrasonic probe holder assemblies mounted to the sliding assembly, a vertically extending second portion of the probe mount positioned adjacent to a leading ultrasonic probe holder of the plurality of ultrasonic probe holders, and a proximity sensor mounted to a lower end of the second portion of the probe mount and in communication with the controller. The proximity sensor can be configured to transmit one or more proximity signals to the controller upon detection of a terminal end of a target adjacent thereto.

In another embodiment, the controller can be configured to receive target information including a rate of advance of the target towards the plurality of ultrasonic probe and a distance between the proximity sensor and the contact of respective ones of the plurality of ultrasonic probe holder assemblies. The controller can be further configured to determine, based upon the received target information and the one or more proximity signals, an estimated time at which the terminal end of the target vertically underlies the contact of respective ones of the plurality of ultrasonic probe holder assemblies. The controller can be additionally configured to command the actuators of respective ones of the plurality of ultrasonic probe holder assemblies to move respective ones of the plurality of ultrasonic probe holder assemblies vertically downward towards the target at a time based upon the estimated time.

### BRIEF DESCRIPTION OF DRAWINGS

These and other features will be more readily understood from the following detailed description taken in conjunction with the accompanying drawings, in which:

FIG. 1A is a schematic diagram illustrating a side cross-sectional view of one exemplary embodiment of an existing ultrasonic testing system including an immersion tank, an ultrasonic probe holder assembly, and a target positioned within the tank;

FIG. 1B is a schematic diagram of the ultrasonic testing system of FIG. 1A illustrating downward actuation of the ultrasonic probe holder assembly and contact of both ends a housing of the ultrasonic testing assembly with the target;

FIG. 1C is a schematic diagram of the ultrasonic testing system of FIG. 1A illustrating downward actuation of the ultrasonic probe holder assembly and contact of a single end of the housing of the ultrasonic testing assembly with the target and resulting rotation R of the ultrasonic probe holder assembly;

FIG. 2A is a diagram illustrating an isometric view of one exemplary embodiment of an improved ultrasonic probe holder assembly including a probe mount, a probe holder, a controller, an actuator, and a gimbal;

FIG. 2B is a diagram illustrating a front view of the improved ultrasonic probe holder assembly of FIG. 2A;

FIG. 3 is a diagram illustrating a side view of the improved ultrasonic probe holder assembly of FIG. 2A, showing the probe holder in greater detail;

FIG. 4A is a diagram illustrating engagement of the probe holder with a target in the form of a round bar having a first diameter;

FIG. 4B is a diagram illustrating engagement of the probe holder with a target in the form of a round bar having a second diameter bigger than the first diameter;

FIG. 5A is a diagram illustrating an isometric view of the gimbal of FIGS. 2A-2C;

FIG. 5B is a diagram illustrating a side view of the gimbal of FIGS. 2A-2C;

FIG. 5C is a diagram illustrating a front view of the gimbal of FIGS. 2A-2C;

FIG. 6A is a cut-away view of a portion of FIG. 3 illustrating the arc plate in greater detail;

FIG. 6B is another view of a portion of the improved ultrasonic probe holder assembly of FIG. 2A illustrating a limit switch;

FIG. 7A is a diagram illustrating a front view of the ultrasonic probe holder assembly of FIG. 2B including a sensor coupled to the probe mount that is configured to detect of a terminal end of the target; and

FIG. 7B is a diagram illustrating a front view of the ultrasonic probe holder assembly showing actuation of the ultrasonic probe holder in response to detection of the terminal edge of the target.

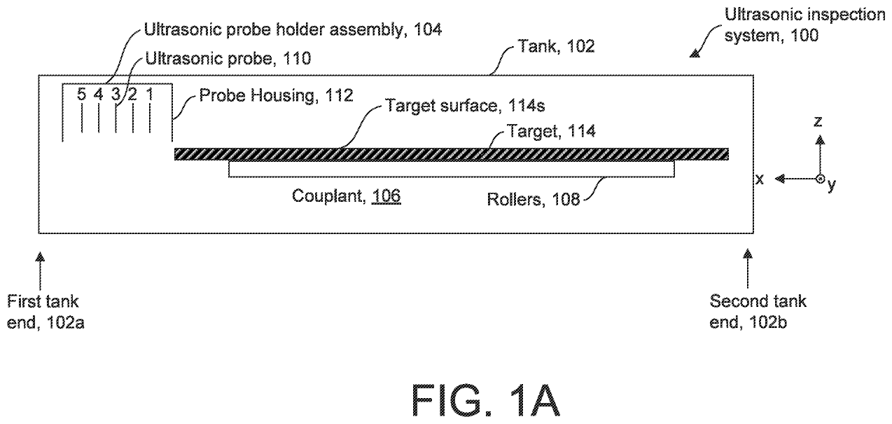

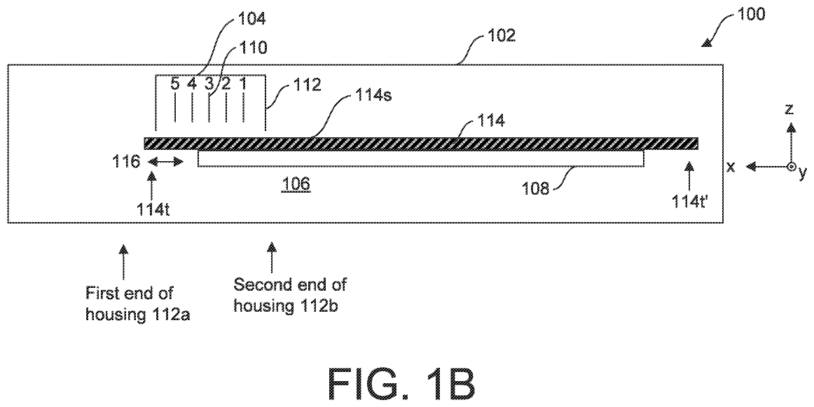

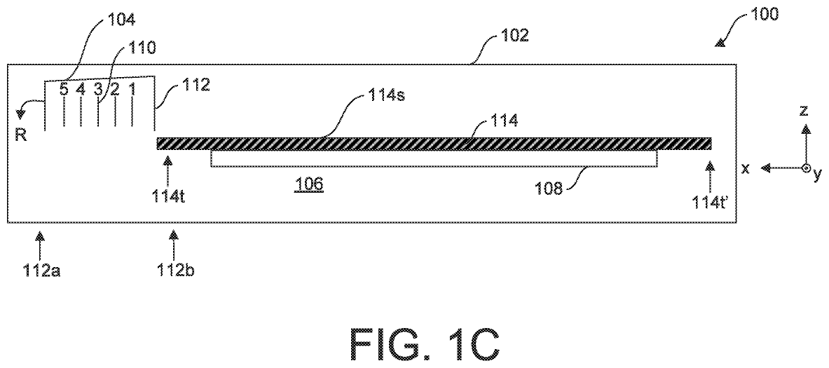

### DETAILED DESCRIPTION

Ultrasonic testing is commonly performed on targets such as round bars to measure target features (e.g., dimensions) and/or identify the presence of internal flaws which can be difficult to detect from the outer surface. However existing ultrasonic testing systems suitable for testing round bars can exhibit several undesirable deficiencies. In one aspect, existing ultrasonic testing systems can contact the target during testing and, as these ultrasonic testing systems are relatively heavy, this contact results in damage to the target surface. In another aspect, existing ultrasonic systems can exhibit a relatively long “dead zone” at the ends of bars where testing cannot be performed. In a further aspect, existing ultrasonic systems can have difficulty following changes in the contour contoured trajectories of the bar. Accordingly, an improved ultrasonic testing system and corresponding methods of use are provided that address these deficiencies.

As discussed in detail below, the improved ultrasonic testing system can include an ultrasonic probe holder assembly with ultrasonic probes mounted to a gimbal, the gimbal can be mounted to a follower plate attached to an arc plate, and the arc plate being spring mounted to a probe holder. The gimbal can allow translation and rotation of the ultrasonic probe with respect to the target. The arc plate and follower plate can be configured to rotate in order to compensate for changes in the contour of the target and thereby maintain normal incidence of ultrasonic signals emitted from the ultrasonic probes. Spring mounting of the arc plate and follower plate to the probe housing frame can reduce the weight applied to the target when the ultrasonic probe holder assembly contacts the target.

Embodiments of ultrasonic probe assemblies and corresponding methods for immersion testing are discussed herein. However, embodiments of the disclosure can be employed with other ultrasonic testing configurations without limit.

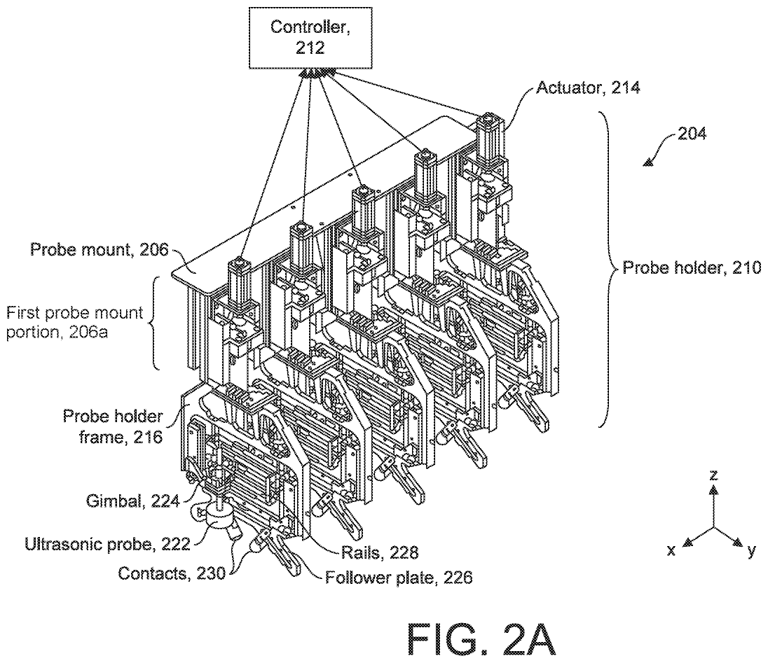

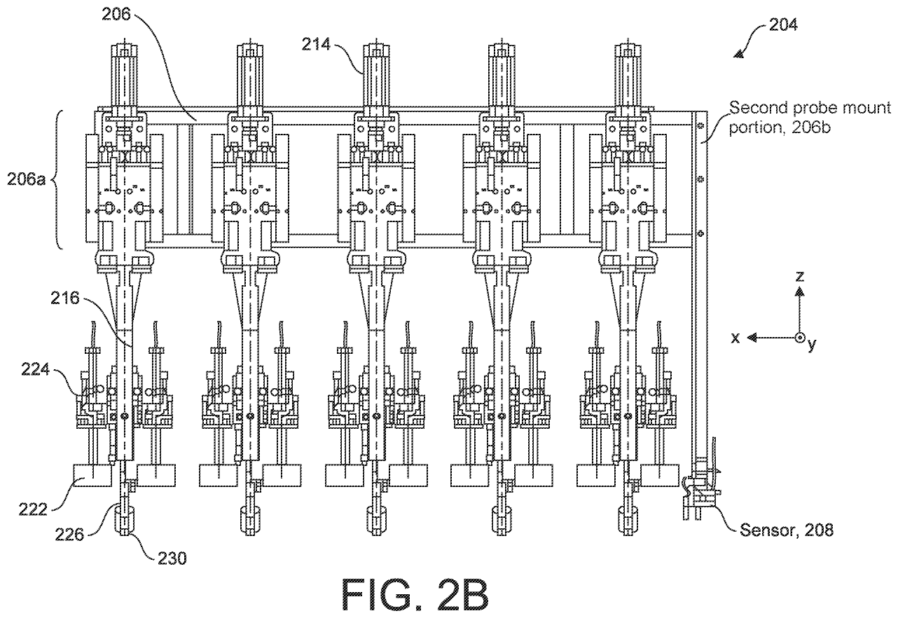

FIGS. 2A-2B are schematic diagrams illustrating isometric and front views of an improved ultrasonic probe holder assembly 204. The ultrasonic probe holder assembly 204 can be used in replacement of the ultrasonic probe holder assembly 104 discussed above in the context of the immersion ultrasonic testing system 100. As shown, the ultrasonic probe holder assembly 204 includes a probe mount 206, a probe holder 210, a controller 212, an actuator 214, and a gimbal 224. As discussed in greater detail below, an ultrasonic probe 222 can be mounted to the gimbal 224.

The probe mount 206 includes a first portion 206a and a second portion 206b. The first portion 206a is generally planar and extends horizontally (e.g., the x-direction). A rear-facing surface of the first portion 206a can be coupled to the sliding assembly to secure the ultrasonic probe holder assembly 204 to the tank 102. The actuator 214 can be coupled to the front-facing surface of the first portion 206a. The second portion 206b is generally planar and extends vertically (e.g., in the z-direction). As discussed in greater detail below, a sensor 208 can be mounted to the second portion 206b of the probe mount 206 for detection of the terminal ends 114t, 114t′ of the target 114.

The probe holder 210 includes a probe holder frame 216, an arc plate 220, a follower plate 226, and a plurality of contacts 230. The actuator 214 is in electrical communication with the controller 212 and is coupled to the first portion 206a of the probe mount 206 (e.g., the front-facing surface) and the probe holder frame 216. The actuator 214 is further configured to actuate up and down (e.g., vertically, in the z-direction) in response to commands received from the controller 212. A top surface of the probe holder frame 216 can be mounted to the actuator 214, while the arc plate 220 can be rotatably or pivotably mounted within an aperture of the probe holder frame 216.

The arc plate 220 can include one or more guide rails 228 mounted on front-facing and/or rear-facing surfaces (e.g., in the x-direction). An ultrasonic probe 222 can mounted to the follower plate 226 via a gimbal 224. The gimbal 224 can be mounted on the guide rails 228. The follower plate 226 is coupled to a lower end of the arc plate 220 and the contacts extend downward from the follower plate 226. In configurations where guide rails are mounted on only one of the front-facing or the rear-facing surface of the arc plate, a single ultrasonic probe can be employed. Alternatively, in configurations where two guide rails are present, one mounted on each of the front-facing and the rear-facing surface of the arc plate, two ultrasonic probes can be employed, one mounted to each of the guide rails.

As discussed in greater detail below, the gimbal 224 can be used to move the ultrasonic probe 222 to which it is attached with respect to the probe holder frame 216, and thus also with respect to the target 114. For example, the y-position (horizontal position) of the ultrasonic probe 222 can be adjusted by movement along the guide rails 228, while the z-position (vertical position) of the ultrasonic probe 222 can be further adjusted independently of the y-position. The gimbal 224 can be further configured to permit rotation about the x-axis, the y-axis, and/or z-axis, as well as translation in the z-direction. In this manner, a sensing face of the ultrasonic probe 222 can translated and/or rotated with respect to the surface of the target 114 to provide approximately normal incidence of the emitted ultrasonic signals with the surface of the target 114.

In operation, the sliding assembly moves the ultrasonic probe holder assembly 204 to a desired location with respect to the target 114 and the target 114 is rotated by the rollers 108. The actuator 214 moves respective probe holders 210 downward such that the contacts 230 contact the outer surface of the target 114. As the arc plate 220 is rotatably mounted to the probe holder frame 216, the arc plate can rotate in-plane (e.g., the y-z plane) to accommodate any irregularities in the contour of the surface of the target 114. As further discussed below, the arc plate 220 can be spring-mounted to the probe holder frame 216 in order to reduce the weight of the ultrasonic probe holder assembly 204 applied to the target 114. This configuration prevents damage to the target 114 from contact of the probe holder 210 with the target 114.

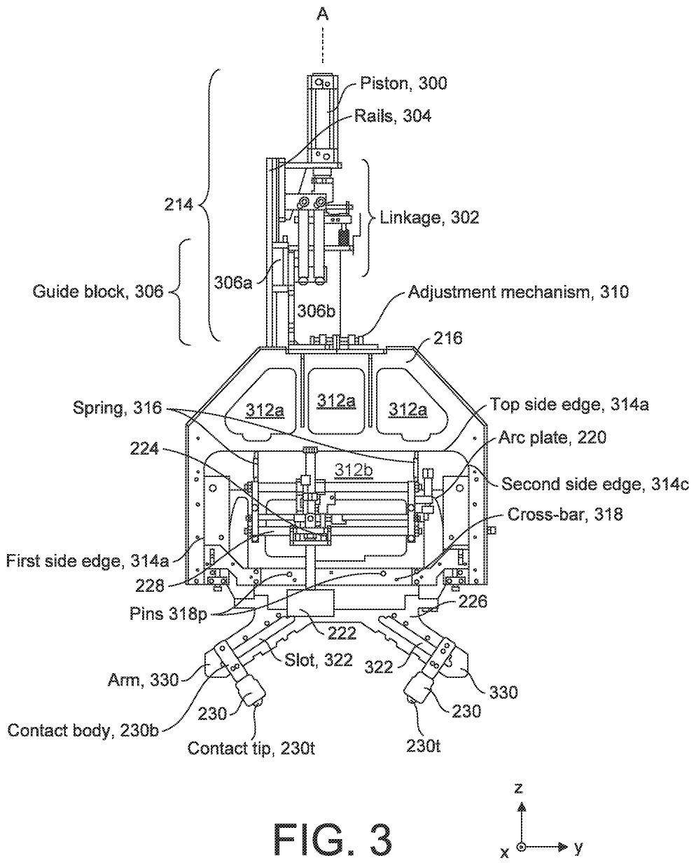

FIG. 3 is a diagram illustrating a side view of the ultrasonic probe holder assembly of FIG. 2A showing the probe holder 210 in greater detail. As shown, the actuator 214 includes a piston 300, a linkage 302, a pair of rails 304, a guide block 306, and an adjustment mechanism 310.

An upper surface of the linkage 302 is connected to the piston 300 and a side surface of the linkage 302 is connected to the guide block 306. The guide block 306 includes a generally rectangular first portion 306a that is configured to engage with the rails 304 and a generally rectangular second portion 306b that extends in the z-direction that is configured to couple the first portion 306a of the guide block 306 to the adjustment mechanism 310.

The piston 300 can be a pneumatic device configured to actuate in the up-down direction (e.g., the z-direction), approximately parallel to a vertical axis A of the ultrasonic probe holder assembly 204 in response to commands from the controller 312. When actuated, the first portion 306a of the guide block 306 is constrained by the rails 304 to move in the vertical direction. The adjustment mechanism 310 is further configured to allow the probe holder frame 216 to be rotated and held at a predetermined angle with respect to the vertical axis A. As the guide block 306 is coupled to the probe holder frame 216, motion of the piston 300 and guide block 306 cause a corresponding vertical motion of the probe holder frame 216 and components attached thereto (e.g., the arc plate 220, the least one ultrasonic probe 222 and corresponding gimbal 224, the follower plate 226, and the plurality of contacts 230). This configuration provides for large scale vertical movement and rotation of the ultrasonic probe(s) 222 with respect to the surface of the target 114.

The probe holder frame 216 includes a generally planar body having a plurality of apertures formed therethrough (e.g., through a thickness in the x-direction). One or more first apertures 312a of the plurality of apertures can be provided to remove a predetermined amount of material from the probe holder frame 216 for weight reduction. As shown, the first apertures 312a can be adjacent to an upper end of the probe holder frame 216. A second aperture 312b can be formed below the first apertures 312a and dimensioned to receive the arc plate 220 therein. As shown, the second aperture 312b can include an upper edge 314a and opposed side edges 314b, 314c. The second aperture 312b can be open in the downward direction (e.g., opposite the upper edge 314a). That is, second aperture 312b can define an open lower end of the probe holder frame 216.

The arc plate 220 is positioned within the second aperture 312b. As shown, a pair of springs 316 couple the arc plate 220 to the probe holder frame 216. For example, the springs 316 The springs 316 can be coupled to the probe holder frame 216 and the arc plate 220 adjacent to the upper edge of the second aperture 312b. That is, the arc plate 220 is supported within the second aperture 312b by the springs 316. In this manner, the springs 316 act to resist the downward force of gravity, reducing the weight applied by the arc plate 220 and components attached thereto (e.g., the ultrasonic probe(s) 222 and corresponding gimbal(s) 224, the follower plate 226, and contacts 230) when the contacts 230 touch the outer surface of the target 114. While two springs 316 are illustrated in FIG. 3, it can be understood that alternative embodiments of the ultrasonic probe holder assembly can include greater or fewer springs as necessary. The net weight of applied by the ultrasonic probe holder assembly 204 can be adjusted by changing the length of the springs 316.

The probe holder can further include a cross-bar 318 extending between the opposed first and second side edges 314b, 314c of the second aperture 312b. One or more pins 318p can be mounted to the cross-bar 318, extending in a direction out of the plane of the arc plate 220. So configured, when the arc plate 220 is not rotated (not pivoted), a lower end of the arc plate 220 can contact the one or more pins 318p, supporting the weight of the arc plate 220 and components attached to the arc plate 220 (e.g., the least one ultrasonic probe 222 and corresponding gimbal 224, the follower plate 226, and the plurality of contacts 230).

An upper end of the follower plate 226 can be mounted to a lower end of the arc plate 220. The follower plate 226 can include arms 330 extending laterally outward from the vertical axis A in the plane of the arc plate 220 (e.g., in the y-z plane). The arms 330 can include respective slots 322 to which the contacts 230 are slidably mounted. So mounted, the contacts extend in the vertical direction (e.g., the x-direction). As an example, the contacts 230 can include a contact body 230b and a contact tip 230t positioned at a terminal end of the contact 230 for engaging the target 114 (e.g., at a lowermost point of the probe holder 210). The contact tip 230t can be a ball and socket. The ball and socket configuration of the contact tip 230t can minimize contact area and friction between the contact 230 and the surface of the target 114.

As discussed in greater detail below, the arc plate 220 can be pivotably mounted to the probe holder frame 216, allowing the arc plate 220 to rotate when the surface of the target 114 exhibits an irregular contour. An irregular contour can be a portion of the target surface that is closer to the probe holder frame 216 (e.g., a protrusion) or farther from the probe holder frame (e.g., a recess) as compared to a nominal position (e.g., radius) of the target surface. When encountering an irregular contour, the contacts 230 and follower plate 226 can move vertically, causing the arc plate 220 to pivot. Beneficially, the ability of the arc plate 220 to pivot allows the probe holder to accommodate the vertical movement of the contacts 230 and the follower plate 226 and to keep the distance between the sensing surface of the ultrasonic probe(s) 222 and the surface of the target 114 approximately constant. In this manner, normal incidence of the ultrasonic signals with the surface of the target 114 and the relative position of the focal region of the ultrasonic signals with respect to the surface of the target 114, can be maintained when the surface of the target 114 exhibits an irregular contour.

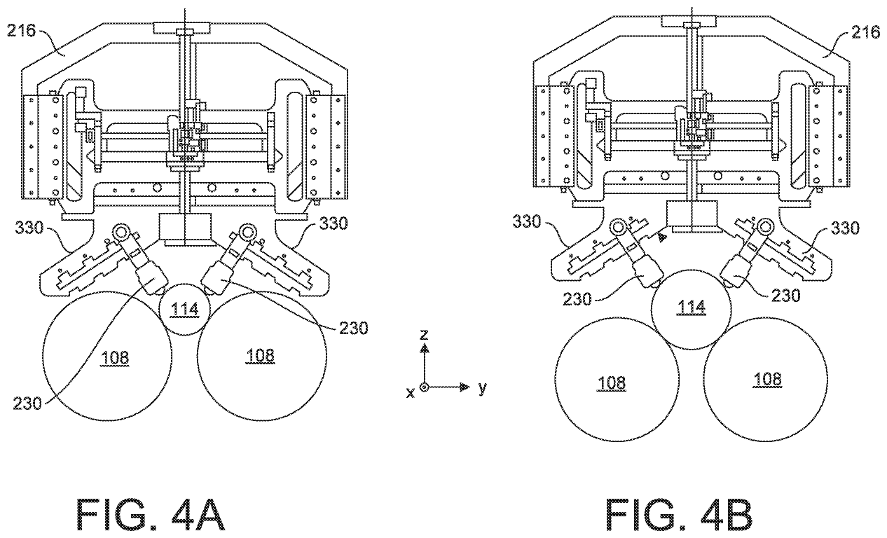

FIGS. 4A-4B are diagrams illustrating engagement of the contacts 230 with a target 114 in the form of a round bar having a first diameter and a second diameter larger than the first diameter, respectively. The slidable mounting configuration of the contacts 230 to the follower plate 226 allows the contacts 230 to be moved within the slots 322, changing the separation distance between respective contact tips 230t to accommodate targets 114 having different diameters.

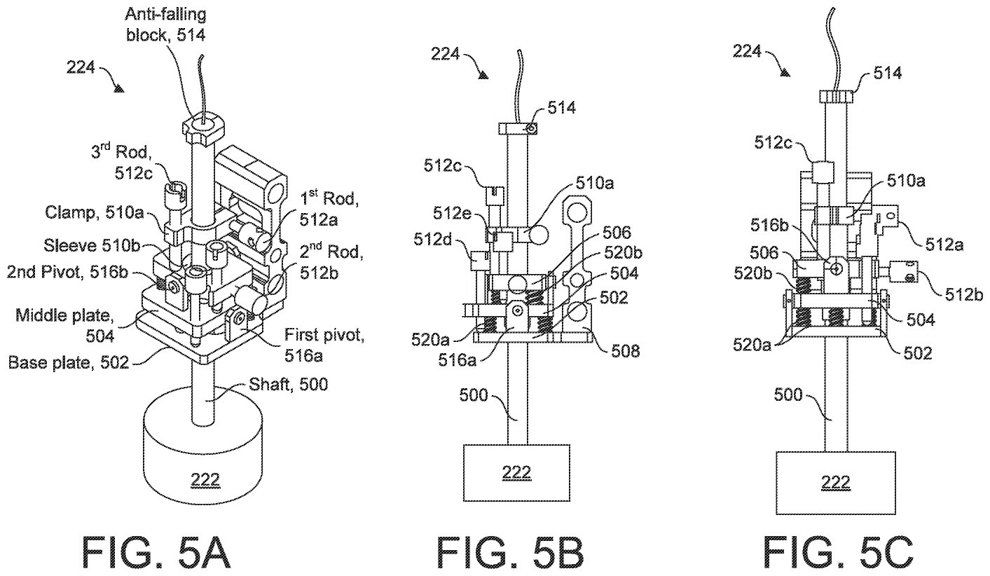

The one or more guide rails 228 can be mounted to the arc plate 220 and extend generally horizontally in the y-direction. The gimbal 224 is slidably mounted on the guide rails for support and adjustment of the horizontal position of the gimbal 224. The gimbal 224 is illustrated in greater detail in FIGS. 5A-5C. FIG. 5A-5C present an isometric view, a side view (facing the x-direction), and a front view (facing the y-direction) of the gimbal 224, respectively. The gimbal includes a shaft 500 about which a plurality of horizontally extending plates (e.g., base plate 502, a middle plate 504, and an upper plate 506) are disposed and vertically offset from one another. The middle plate 504 is positioned between the base plate 502 and the upper plate 506. The ultrasonic probe 222 is coupled to a lower end of the shaft 500.

The base plate 502 is rigidly coupled to the shaft 500 and a slidable mount 508. The slidable mount 508 includes a plurality of apertures configured to receive corresponding ones of the guide rails 228. The gimbal 224 is supported on the guide rails 228 by the slidable mount 508.

The gimbal 224 can further include a first clamp 510a, a second clamp 510b (e.g., a sleeve clamp), a first adjustable rod 512a, a second adjustable rod 512b, and a third adjustable rod 512c. As an example, the adjustable rods 512a, 512b, 512c can be set screws. The first clamp 510a can be disposed about the shaft 500 at a first vertical location (e.g., vertically above the upper plate 506) and configured to open and close according to actuation of the first adjustable rod 512a. The second clamp 510b can be disposed about the shaft 500 at a second vertical location (e.g., inset within the upper plate 506) and configured to open and close according to actuation of the second adjustable rod 512b.

In certain embodiments, the first clamp 510a can be configured to exert a first clamping force on the shaft 500 when closed. The second clamp 510b can be configured to exert a second clamping force on the shaft 500 when closed. The second clamping force can be greater than the first clamping force.

In order to make relatively large vertical movements of the ultrasonic probe 222 with respect to the target 114 in the z-direction, and/or relatively large rotation of the ultrasonic probe 222 about the z-axis, the first and adjustable second rods 512a, 512b can be moved such that the first clamp 510a and the second clamp 510b are completely opened. This reduces the friction force between the first clamp 510a the second clamp 510b, and the shaft 500 to a level that allows relatively large translational and/or rotational movements of the shaft 500 (e.g., by hand). The shaft 500 can be supported by hand. However, an anti-falling block 514 can also be provided at the end of the shaft 500 opposite the ultrasonic probe 222 to prevent the shaft 500 from being removed from the plurality of plates (e.g., by falling due to gravity).

In order to make relatively small vertical movements of the ultrasonic probe 222 with respect to the target 114, about the z-axis, the first and adjustable second rods 512a, 512b can be moved such that the first clamp 510a can be completely closed, while the second clamp 510b can be opened. So configured, there is substantially no clamping force between the second clamp 510b and the shaft 500 and a modest clamping force between the first clamp 510a. The first clamping force can be sufficient to support the shaft 500 and ultrasonic probe 222 (e.g., the shaft 500 does not substantially move with respect to the plurality of plates 502, 504, 506 and the slidable mount 508) and to allow relatively small, accurate movements of plurality of plates with respect to the shaft 500 by actuation of the third adjustable rod 512c. That is, by rotating the third adjustable rod 512c, the accurate threads of the third adjustable rod 512c ensures the vertical movement accurately.

Once the shaft 500 is positioned at a desired vertical and rotational position, the first and adjustable second rods 512a, 512b can be moved such that both the first clamp 510a and the second clamp 510b are closed to increase the friction force between the first clamp 510a, the second clamp 510b, and the shaft 500 to a level that inhibits translational and rotational movements of the shaft 500 and locks the translational and rotational position of the ultrasonic probe 222.

With further reference to FIGS. 5A-5C, the base plate 502 and the middle plate 504 can be connected by a first pivot 516a and a fourth adjustable rod 512d. The first pivot 516a can extend approximately parallel to the horizontal direction. The middle plate 504 and the upper plate 506 can be connected by a second pivot 516b and a fifth adjustable rod 512e. A plurality of first gimbal springs 520a can be positioned between, and connected to, the base plate 502 and the middle plate 504. The plurality of first gimbal springs 520a can be a pair of first gimbal springs positioned on opposite sides of the first pivot 516a. A plurality of second gimbal springs 520b can be positioned between, and connected to, the middle plate 504 and the upper plate 506. The plurality of second gimbal springs 520b can be a pair of gimbal springs positioned on opposite sides of the second pivot 516b.

The fourth adjustable rod 512d can be rotated to vertically actuate and thereby cause the middle plate 504 to rotate about the first pivot 516a (e.g., about the y-axis). Actuation of the fourth adjustable rod 512d to move the middle plate 504 upwards causes the middle plate to rotate clockwise, while actuation of the fourth adjustable rod 520d to move the middle plate 504 downwards causes the middle plate 504 to rotate counterclockwise. As the shaft 500 is coupled to the plurality of plates 502, 504, 506 when the first and second clamps 510a, 510b are closed, rotation of the middle plate 504 about the y-axis causes corresponding rotation of the ultrasonic probe 222 about the y-axis. The first gimbal springs 520a are configured to oppose rotation of the middle plate 504 about the y-axis. Thus, when the fourth adjustable rod 512d is not actuated, the rotational position of the middle plate 504, and therefore the ultrasonic probe 222, remains constant.

The fifth adjustable rod 512e can be actuated to cause the upper plate 506 to rotate about the second pivot 516b (e.g., about the x-axis). Actuation of the fifth adjustable rod 512e to move the upper plate 506 upwards causes the middle plate to rotate clockwise, while actuation of the fifth adjustable rod 512e to move the upper plate 506 downwards causes the upper plate 506 to rotate counterclockwise. As the shaft 500 is coupled to the plurality of plates when the first and second clamps 510a, 510b are closed, rotation of the upper plate 506 plate about the x-axis causes corresponding rotation of the ultrasonic probe 222 about the x-axis. The second gimbal springs 520b are configured to oppose rotation of the upper plate 506 about the x-axis. Thus, when the fifth adjustable rod 512e is not actuated, the rotational position of the upper plate 506, and therefore the ultrasonic probe 222, remains constant.

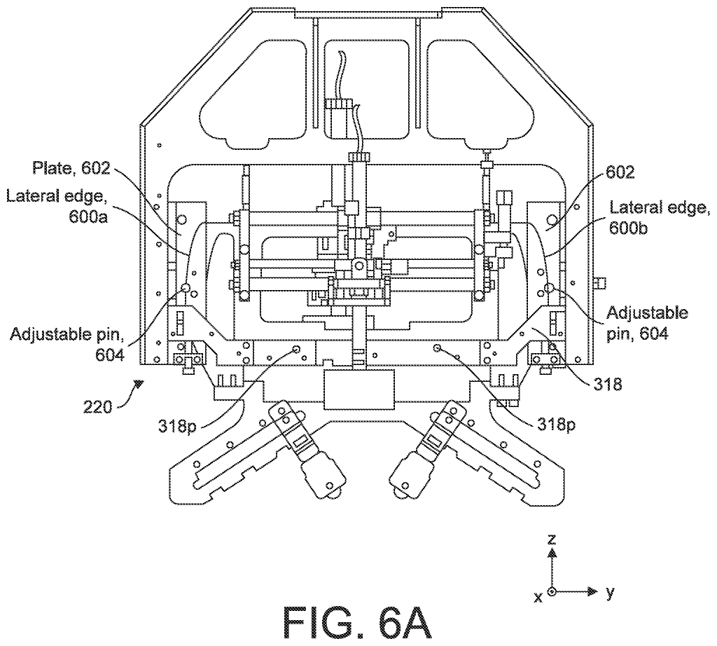

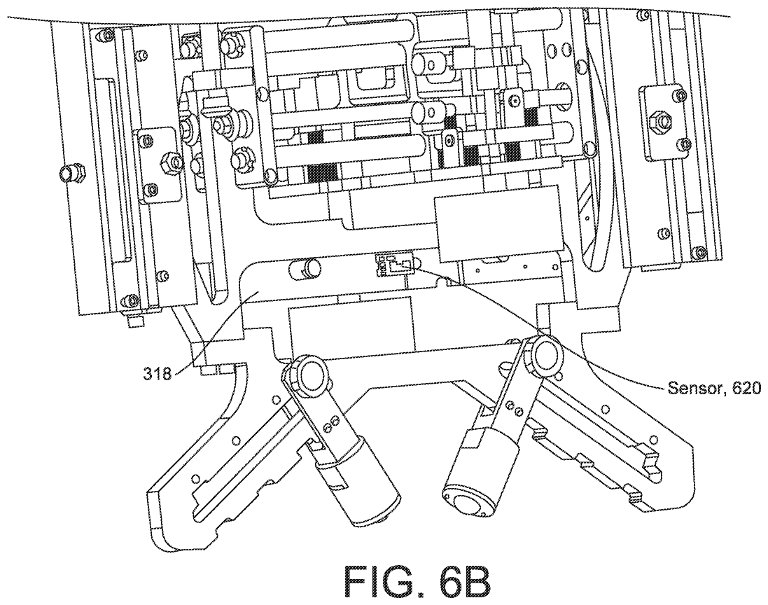

FIG. 6 is a diagram of a cut-away view of a portion of FIG. 3 that illustrates the arc plate 220 in greater detail. As shown, the arc plate 220 extends between opposed lateral edges 600a, 600b that are curved. Each of the lateral edges 600a, 600b can be constrained in the y-z plane by a pair of generally flat, rectangular plates 602. To better illustrate the lateral edges 600a, 600b, the plates 602 in front of the lateral edges 600a, 600b are removed from FIG. 6.

An adjustable pin 604 is provided on each lateral side of the arc plate 220, adjacent to the lateral edges 600a, 600b. The adjustable pin can be configured to adjust a frictional resistance against rotation (and thus pivoting) of the arc plate 220. As an example, in one embodiment, the adjustable pin 604 can be a threaded rod having a head. Increasing the clamping force applied by the adjustable pin 604 against the arc plate 220 can increase the frictional resistance, while decreasing the clamping force applied by the adjustable pin 604 against the arc plate 220 can decrease the frictional resistance. It can be appreciated that, in further embodiments, the number of adjustable pins can be varied. For example, a single adjustable pin can be employed on a single side of the arc plate, rather than an adjustable pin on each side of the arc plate.

FIG. 6B is a side view of the probe holder 210 of FIG. 2A illustrating a sensor 620 mounted to the cross-bar 318 and in communication with the controller 212. The sensor 620 is configured to act as a z-axis limit switch. When moving the ultrasonic probe holder assembly 204 down in the z-direction, the contact tip 230t touches the target surface 114s and the follower plate 226 and arc plate 220 move up in the z-direction. This upward (vertical) motion of the arc plate 220 activates the sensor 620, resulting in transmission of a limit switch signal to the controller 312. Upon receipt of the limit switch signal, the controller 312 is configured to command the motor (e.g., the actuator 214) controlling the z-direction movement to cease downward movement of the probe holder frame 216. Beneficially, use of such sensing facilitates positioning the ultrasonic probe holder assembly 204 in the z-direction at a height that the contact 230t gently contact the target surface 114s and avoid collision.

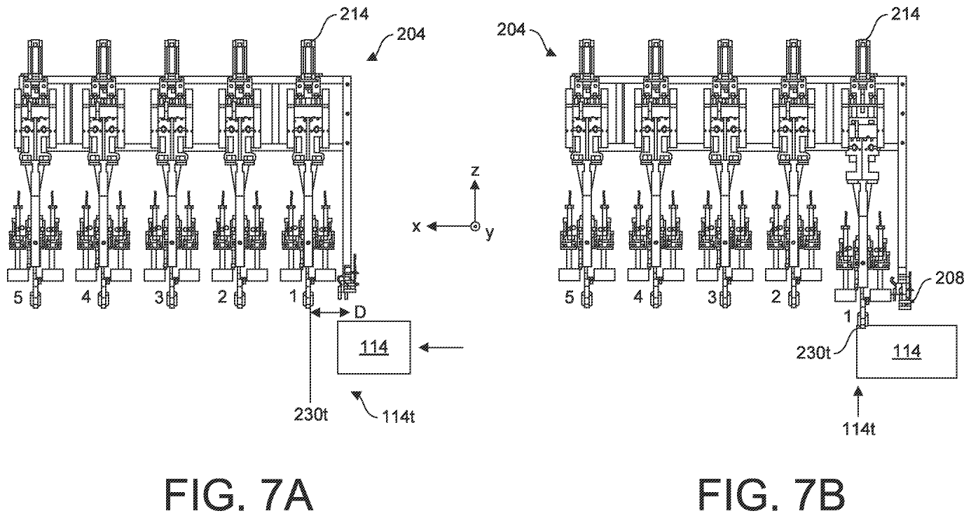

FIGS. 7A-7B are diagrams illustrating a front view of a plurality of ultrasonic probe holder assemblies 204 including a respective probe holders 210, numbered 1-5, and the sensor 208 configured to detect of a terminal end (e.g., 114t, 114t′) of the target 114. As shown, the sensor 208 is mounted to a lower end of the second portion 206b (e.g., adjacent to the target 114). As an example, the sensor 208 can be a proximity sensor. The second portion 206b of the probe mount 206 is further positioned adjacent to a leading ultrasonic probe holder assembly of the plurality of ultrasonic probe holder assemblies 204 (e.g., ultrasonic probe holder assembly 1). That is, the leading ultrasonic probe holder assembly can be the one of the plurality of ultrasonic probe holder assemblies 204 that is closest to the target 114 as it advances towards the plurality of ultrasonic probe holder assemblies 204.

As the terminal end 114t of the target 114 approaches the sensor 208, it is detected by the sensor 208. Subsequently, the sensor 208 sends one or more proximity signals to the controller 312 reporting the detection of the terminal end 114t. In certain embodiments, the rate of advance of the target 114 towards the ultrasonic probe holder assembly 204 and a horizontal distance D between the sensor and respective ones of the contacts 230 can be known (e.g., retrieved by or transmitted to the controller 212 from a memory). With this information, estimated times at which the terminal end 114t underlies respective ones of the plurality of ultrasonic probe holders by a predetermined distance can be determined (e.g., by the controller 312).

The controller 312 can be further configured to transmit commands to respective actuators 214 to actuate so as to bring the contact 230 of respective ultrasonic probe holder assemblies 1-6 into contact with the target 114 based upon the estimated times. As an example, the controller 312 can use the determined times, along with a known delay time (e.g., a time for the terminal end 114t to travel a predetermined distance) to bring the contact 230 of respective ultrasonic probe holder assemblies 1-6 into contact with the target 114 at approximately the predetermined distance from the terminal end 114t of the target 114. In this manner, embodiments of the ultrasonic probe holder assembly 204 can drastically reduce the dead zone as compared to existing ultrasonic testing systems.

Exemplary technical effects of the methods, systems, and devices described herein include, by way of non-limiting example an ultrasonic probe holder assembly configured to position of an ultrasonic probe mounted thereto with respect to a target to provide normal or approximately normal incidence of emitted ultrasonic beams with a surface of the target. In one aspect, the ultrasonic probe holder assembly includes a gimbal coupled to the ultrasonic probe and configured to allow for rotation of the ultrasonic probe (e.g., about the x-, y-, and z-directions) as well as translation in the y- and z-directions. The ability to adjust the rotational and translational position of the ultrasonic probe can facilitate normal/near normal alignment of the ultrasonic beams with the target surface. In another aspect, a portion of the ultrasonic probe holder (e.g., the arc plate and follower plate) can be configured to rotate in order to compensate for changes in the contour of the target. Beneficially, this configuration can help to maintain the normal/near normal incidence of ultrasonic beams with the target surface. In a further aspect springs can be used to support a portion of the weight of the ultrasonic probe assembly and the ultrasonic probe, facilitating relatively light contact between the ultrasonic probe assembly and the target surface to avoid damaging the target surface. The ultrasonic probe holder assembly can be further configured to sense approach of a terminal end of the target and determine a time at which to actuate the probe holder assembly into contact with the target that minimizes the dead zone at the ends of the target where ultrasonic inspection is not performed.

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in analog electronic circuitry, digital electronic circuitry, and/or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

1. An ultrasonic probe holder, comprising:
a probe holder frame having a generally planar body and at least one aperture extending therethrough, wherein an aperture of the at least one aperture is open in the downward direction and defines an open lower end of the probe holder frame;
an arc plate positioned within the aperture and extending between opposed, curved lateral edges, wherein the arc plate is coupled to the probe holder frame, and wherein the lateral edges are constrained in the plane of the probe holder frame;
a follower plate mounted to a lower end of the arc plate and including arms extending laterally outward from a vertical axis in the plane of the arc plate, and
a plurality of contacts slidably mounted to the arms of the follower plate and extending in the vertical direction;
wherein the arc plate is further configured to pivot with respect to the probe holder frame in response to vertical movement of one or more of the plurality of contacts.

2. The ultrasonic probe holder of claim 1, wherein the arc plate is mounted to the probe holder frame by one or more springs.

3. The ultrasonic probe holder of claim 2, further comprising:
a cross-bar extending between opposed lateral edges of the aperture; and
at least one first pin mounted to the cross-bar and extending in a direction out of the plane of the arc plate;
wherein, when the arc plate is not pivoted, the lower end of the arc plate contacts the at least one first pin.

4. The ultrasonic probe holder of claim 1, further comprising at least one second pin positioned adjacent to a lateral edge of the arc plate and configured to adjust a frictional resistance against pivoting of the arc plate.

5. The ultrasonic probe holder of claim 1, wherein the contact comprises a contact body and a contact tip positioned at a terminal end of the contact.

6. The ultrasonic probe holder of claim 5, wherein the contact tip comprises a ball and socket.

7. An ultrasonic probe holder assembly, comprising:
the ultrasonic probe holder of claim 1;
a controller including at least one processor;
an actuator coupled to the probe holder frame and configured to move in a vertical direction in response to commands received from the controller; and
a probe mount including a horizontally extending first portion, wherein a front-facing surface of the first portion of the probe mount is coupled to the actuator.

8. The ultrasonic probe holder assembly of claim 6, further comprising a limit switch mounted to the cross-bar and in electrical communication with the controller, wherein the limit switch is configured to transmit a limit switch signal to the controller in response to upward motion of the arc plate during downward movement of the probe holder frame by the actuator, and wherein the controller is configured to command the actuator to stop the downward movement in response to receipt of the limit switch signal.

9. The ultrasonic probe holder assembly of claim 6, further comprising:
one or more guide rails mounted to the arc plate and extending in a horizontal direction;
a gimbal slidably mounted to the one or more guide rails; and
an ultrasonic probe mounted to the gimbal;
wherein the gimbal is configured to rotate the ultrasonic probe with respect to the probe holder frame and to vertically translate the ultrasonic probe with respect to the probe holder frame.

10. The ultrasonic probe holder assembly of claim 8, wherein the gimbal comprises:
a vertically extending shaft extending between a lower end and an upper end;
a plurality of horizontally extending plates disposed about the shaft and vertically offset from one another, the plurality of plates including:
a base plate rigidly coupled to the shaft;
an upper plate; and
a middle plate vertically positioned between the base plate and the upper plate; and
a slidable mount coupled to the base plate and including a plurality apertures configured to receive corresponding ones of the guide rails;
wherein the ultrasonic probe is coupled to the lower end of the shaft.

11. The ultrasonic probe holder assembly of claim 10, wherein the gimbal further comprises:
a first clamp disposed about the shaft at a first vertical location and configured to exert a first clamping force on the shaft when closed;
a second clamp disposed about the shaft at a second vertical location, and configured to exert a second clamping force on the shaft when closed that is greater than the first clamping force; and
a third adjustable rod coupled to the first clamp and configured to vertically actuate to move the plurality of plates vertically with respect to the shaft.

12. The ultrasonic probe holder assembly of claim 11, wherein the gimbal further comprises:
a first pivot extending in the horizontal direction and connecting the base plate and the middle plate;
a fourth adjustable rod coupled to the base plate and the middle plate; and
a first pair of gimbal springs positioned between the base plate and the middle plate, wherein a first gimbal spring of the first pair is further positioned on one side of the first pivot and a second gimbal spring of the first pair is further positioned on the side of the first pivot opposite the first gimbal spring of the first pair;
wherein the fourth adjustable rod is actuatable in the vertical direction to cause the middle plate to rotate about the first pivot.

13. The ultrasonic probe holder assembly of claim 12, wherein when the first clamp and the second clamp are closed, rotation of the middle plate about the first pivot causes corresponding rotation of the ultrasonic probe about the first pivot, and wherein the first pair of gimbal springs oppose the rotation about the first pivot such that the rotational position of the middle plate and the ultrasonic probe is approximately constant absent actuation of the fourth adjustable rod.

14. The ultrasonic probe holder of claim 11, wherein the gimbal further comprises:
a second pivot extending orthogonal to the horizontal direction and the vertical direction and connecting the middle plate and the upper plate;
a fifth adjustable rod coupled to the middle plate and the upper plate; and
a second pair of gimbal springs positioned between the middle plate and the upper plate, wherein a first gimbal spring of the second pair is further positioned on one side of the second pivot and a second gimbal spring of the second pair is further positioned on the side of the second pivot opposite the first gimbal spring of the second pair;
wherein the fifth adjustable rod is actuatable in the vertical direction to cause the upper plate to rotate about the second pivot.

15. The ultrasonic probe holder assembly of claim 14, wherein when the first clamp and the second clamp are closed, rotation of the upper plate about the second pivot causes corresponding rotation of the ultrasonic probe about the second pivot, and wherein the second pair of gimbal springs oppose the rotation about the second pivot such that the rotational position of the upper plate and the ultrasonic probe is approximately constant absent actuation of the fifth adjustable rod.

16. An ultrasonic testing system, comprising:
the ultrasonic probe holder assembly of claim 7;
a tank configured to contain a liquid couplant; and
a sliding assembly configured to move horizontally with respect to the tank and coupled to a rear-facing surface of the first portion of the probe mount.

17. The ultrasonic testing system of claim 16, further comprising:
a plurality of ultrasonic probe holder assemblies mounted to the sliding assembly;
a vertically extending second portion of the probe mount positioned adjacent to a leading ultrasonic probe holder of the plurality of ultrasonic probe holders; and
a proximity sensor mounted to a lower end of the second portion of the probe mount and in communication with the controller;
wherein the proximity sensor is configured to transmit one or more proximity signals to the controller upon detection of a terminal end of a target adjacent thereto.

18. The ultrasonic testing system of claim 18, wherein the controller is configured to:
receive target information including a rate of advance of the target towards the plurality of ultrasonic probe and a distance between the proximity sensor and the contact of respective ones of the plurality of ultrasonic probe holder assemblies;
determine, based upon the received target information and the one or more proximity signals, an estimated time at which the terminal end of the target vertically underlies the contact of respective ones of the plurality of ultrasonic probe holder assemblies; and
command the actuators of respective ones of the plurality of ultrasonic probe holder assemblies to move respective ones of the plurality of ultrasonic probe holder assemblies vertically downward towards the target at a time based upon the estimated time.
